(19) United States
(12) Patent Application Publication
(10) Pub. No.: US 2008/0252609 A1
(43) Pub. Date: Oct. 16, 2008

(54) Image display and touch input integration module

(76) Inventors: Yan-Zhi Lu, Baoshan Township (TW); Kuei-Hsiung Chen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/785,107

(22) Filed: Apr. 16, 2007

(51) Int. Cl. G06F 3/041

(52) U.S. Cl. 345/173

(57) ABSTRACT

An image display and touch input integration module includes a keyboard microcontroller connected to an image memory, a touch module, and a display module, and selectively operable in a touch mode or a display mode. The image memory has at least one image data stored thereon. The touch module defines a touch area therein. The display module is integrated with the touch module and defines a display area therein for displaying image data read by the keyboard microcontroller from the image memory. When the keyboard microcontroller operates in the touch mode, the touch module functions as an input device of a computer apparatus; and when the keyboard microcontroller operates in the display mode, image data read by it from the image memory is displayed in the display area of the display module.

### FIELD OF THE INVENTION

The present invention relates to a touch module; and more particularly to an image display and touch input integration module that integrates a display module with a touch module.

### BACKGROUND OF THE INVENTION

Due to quick development in computer-related technologies, computer apparatus have been widely used in all kinds of commercial and industrial fields to fulfill different daily life requirements. Computer apparatus provide powerful functions in word processing, control, drawing, etc., and are therefore used to perform or aid in many works to achieve the highest working efficiency, the best activity effect, and the most convenient living conditions.

A user has to use various types of input devices, such as a keyboard, a mouse, a touch panel, and/or a track ball, to operate and control a computer apparatus.

Among others, the keyboard and the mouse are the most common input devices for the computer apparatus. Generally, a notebook computer is provided with a touch panel and an operating unit as input devices thereof to replace the mouse. However, the currently available touch panel generally has only very simple functions for a user to control the movement of a mouse cursor on the screen or to select an object on the screen.

Most recently improvements made to the touch panel are limited to the position of the touch panel on the computer apparatus, the configuration of the touch panel, and the comfortableness of the touch panel for use. There has not been any improvement made to the function of the touch panel to further increase the economical benefits possibly provided by the touch panel.

### SUMMARY OF THE INVENTION

It is therefore a primary object of the present invention to provide an image display and touch input integration module that integrates a display module with a touch module for a user to use the touch module as an input device of a computer apparatus and display image data in the display module.

Another object of the present invention is to provide an image display and touch input integration module, in which at least one animated image databank, at least one background image databank, and an image progress databank are stored. The image progress databank records the progress of change of the displayed images; and image data stored in the animated image databank and the background image databank may be displayed on the integration module.

To achieve the above objects, in accordance with the present invention, there is provided an image display and touch input integration module. The image display and touch input integration module of the present invention is incorporated into a computer apparatus, and has a keyboard microcontroller connected to an image memory, a touch module, and a display module to form an integrated module. With the integration module, a user may use the touch module as an input device to input data into the computer apparatus, use the display module to display image data stored on the image memory, and use the image memory to record the progress of change of displayed image data, making the computer apparatus more practical and powerful for use, and creating more fun and recreational effect in using the computer apparatus.

In brief, the present invention gives a touch panel functions other than moving the mouse cursor and selecting an object on the screen, and accordingly largely increases the commercial value of the touch panel.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing an image display and touch input integration module of the present invention incorporated into a computer apparatus;

FIG. 2 is an exploded perspective view of a touch input and display module included in the integration module of the present invention;

FIG. 3 is a block diagram showing a circuit system for the integration module according to a first embodiment of the present invention;

FIG. 4 is a block diagram showing an image memory for the integration module according to the first embodiment of the present invention;

FIGS. 5 and 6 show the integration module of the present invention in use; and

FIG. 7 is a block diagram showing a circuit system for the integration module according to a second embodiment of the present invention.

### DETAILED DESCRIPTION OF THE PREFERRED EMBODIMENTS

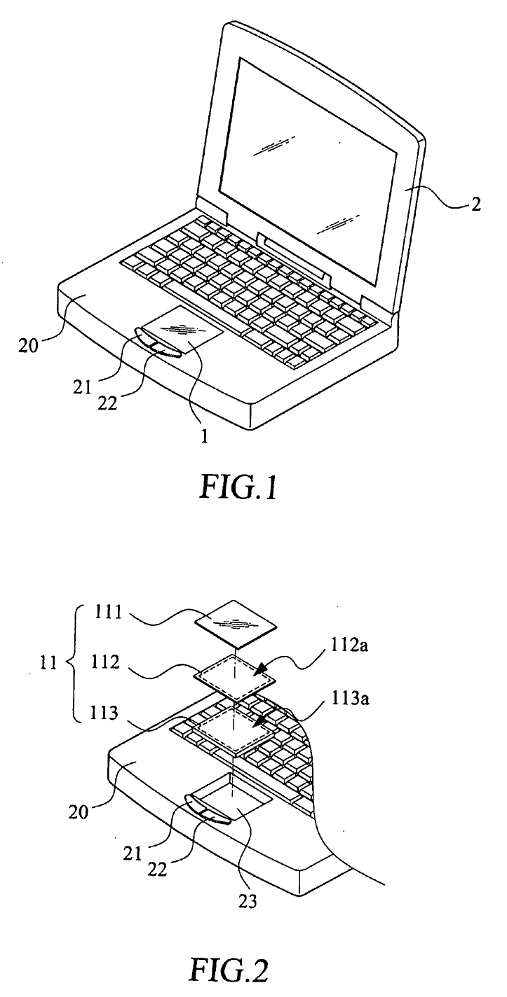

Please refer to FIGS. 1 and 2. An image display and touch input integration module 1 according to the present invention is incorporated into a computer apparatus 2, and includes a touch input and display module 11. As shown, the touch input and display module 11 includes a protective layer 111, a touch module 112, and a display module 113; and the computer apparatus 2 is provided on a housing 20 thereof with at least one operating unit 21, 22 and a receiving recess 23. The protective layer 111, the touch module 112, and the display module 113 of the touch input and display module 11 are sequentially received in the receiving recess 23 from top to bottom.

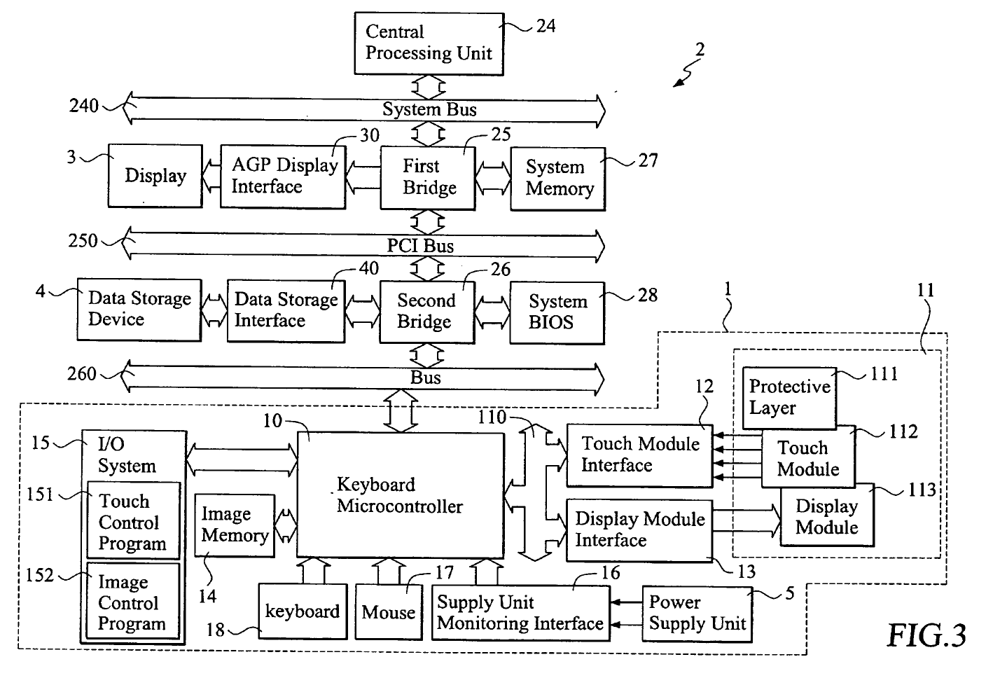

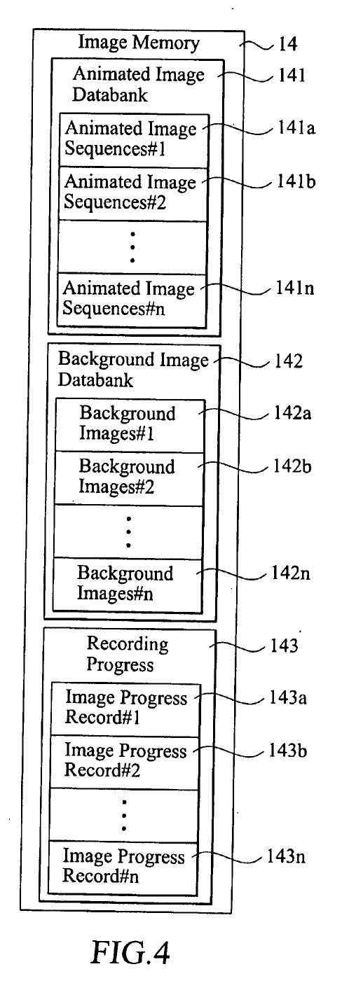

Please refer to FIGS. 3 and 4. The computer apparatus 2 includes a central processing unit (CPU) 24, a first bridge 25, which is normally referred to as a Host Bridge or a North Bridge, and a second bridge 26, which is normally referred to as a South Bridge. The CPU 24 is connected via a system bus 240 to the first bridge 25, and the first bridge 25 is further connected to a system memory 27, and to a display 3 via an AGP (Accelerated or Advanced Graphic Port) display interface 30. The CPU is operable in a touch mode or a display mode.

The first bridge 25 is connected to the second bridge 26 via a PCI (Peripheral Component interconnect) bus 250, and the second bridge 26 is further connected to a system basic input/output system (system BIOS) 28, and to a data storage device 4 via a data storage interface 40, so that the data storage device 4 serves as a data storage device of the computer apparatus 2.

The second bridge 26 is connected to the image display and touch input integration module 1 of the present invention via a bus 260. In addition to the touch input and display module 11, the integration module 1 also includes a keyboard microcontroller 10, an operation of which may be switched between a touch mode and a display mode. As having been mentioned above, the touch input and display module 11 includes a protective layer 111, a touch module 112, and a display module 113. As can be seen from FIG. 2, the touch module 112 defines a touch area 112a; the display module 113 is integrated with the touch module 112 and defines a display area 113a; and the protective layer 111 overlaps the touch area 112a defined by the touch module 112, and the display area 113a defined by the display module 113.

The keyboard microcontroller 10 is connected via a bus 110 to a touch module interface 12, which is further connected to the touch module 112 of the touch input and display module 11; and to a display module interface 13, which is further connected to the display module 113 of the touch input and display module 11.

The keyboard microcontroller 10 is also connected to an image memory 14, a keyboard input/output (I/O) system 15, a power supply unit monitoring interface 16, a mouse 17, and a keyboard 18. The image memory 14 has at least one image data stored thereon. Please refer to FIGS. 3 and 4 at the same time. The image memory 14 includes at least one animated image databank 141 having a plurality of animated image sequences 141a, 141b . . . , 141n stored therein; at least one background image databank 142 having a plurality of background images 142a, 142b . . . , 142n stored therein; and an image progress databank 143 for recording progress of changes in displayed images, and having at least one image progress record 143a, 143b . . . , 143n stored therein.

The keyboard I/O system 15 includes a touch control program 151 and an image control program 152. The power supply unit monitoring interface 16 receives power supplied from a power supply unit 5, which may be a battery.

When the keyboard microcontroller 10 operates in the touch mode, the touch module 112 detects a touch signal from the touch area 112a, and the detected touch signal is sent to the computer apparatus 2 via control of the touch control program 151 of the keyboard I/O system 15, so that the touch module 112 may function as an input device of the computer apparatus 2.

On the other hand, when the keyboard microcontroller 10 operates in the display mode, it reads image data from the image memory 14 via control of the image control program 152 of the keyboard I/O system 15, and the read image data is displayed on the display area 113a of the display module 113 via the display module interface 13.

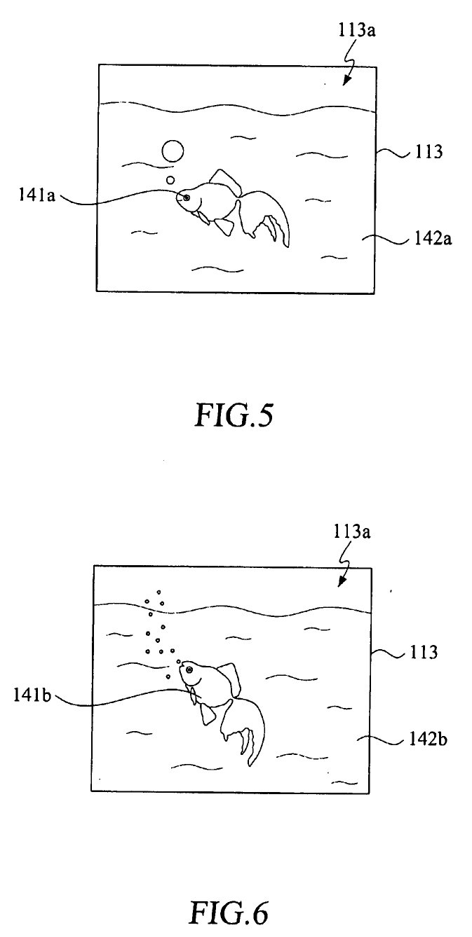

As can be seen from FIG. 5, an animated image 141a in the animated image databank 141 and a background image 142a in the background image databank 142 of the image memory 14 are displayed in the display area 113a on the display module 113. And, FIG. 6 shows another animated image 141b in the animated image databank 141 and another background image 142b in the background image databank 142 of the image memory 14 are displayed in the display area 113a on the display module 113. Meanwhile, the progress of change in the image data displayed in the display area 113a is recorded in the image progress databank 143.

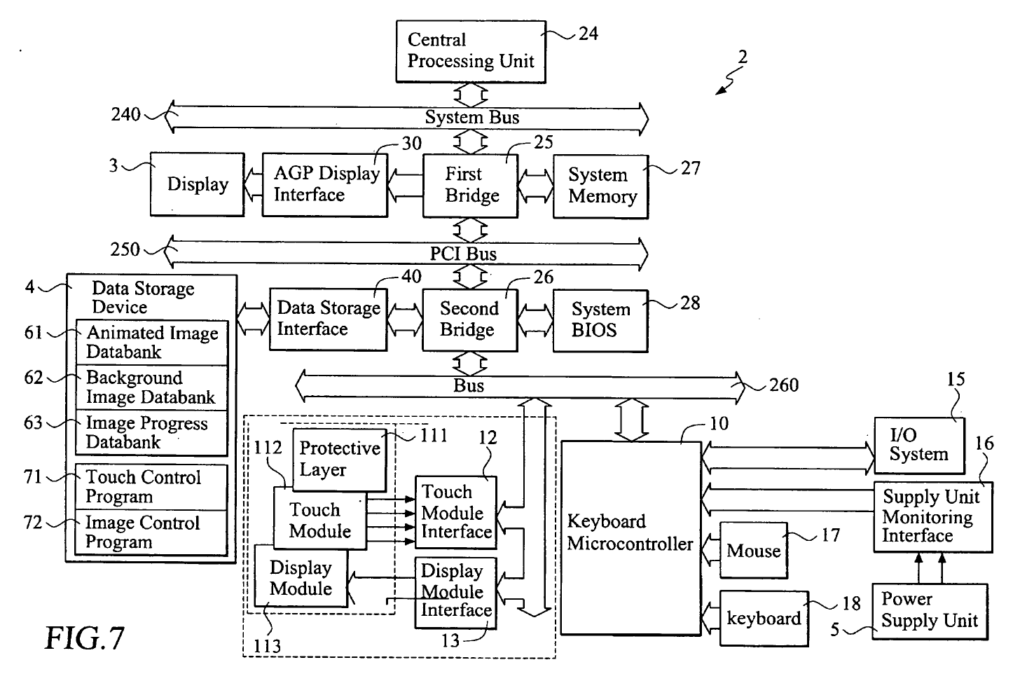

FIG. 7 is a block diagram showing a circuit system for an image display and touch input integration module 1 according to a second embodiment of the present invention. The second embodiment is generally structurally similar to the first embodiment, and the same elements used in the first and the second embodiments are denoted with the same reference numerals. The second embodiment is different from the first one in that the touch module 112 in the touch input and display module 11 is connected via the touch module interface 12 to the bus 260 of the computer apparatus 2, and the display module 113 is connected via the display module interface 13 to the bus 260 of the computer apparatus 2.

The integration module 1 in the second embodiment includes an animated image databank 61, a background image databank 62, and an image progress databank 63, which are stored on the data storage device 4 of computer apparatus 2; and a touch control program 71 and an image control program 72 are also stored on the data storage device 4 of the computer apparatus 2.

In practical design of the present invention, it is also possible for the touch area 112a defined by the touch module 112 and the display area 113a defined by the display module 113 to be two independent areas without overlapping each other. And, when the computer apparatus 2 is shut down, the integration module 1 may still be powered by the power supply unit 5 to operate independently.

The animated image sequences in the animated image databank 141, 61 may be a sequence of images showing animals in different positions. The animals may be, for example, goldfish as illustrated in FIGS. 5 and 6; and may be any other types of animal, such as dog, cat, bird, etc., depending on the field in which the integration module 1 is to be used. Alternatively, the animated image sequences may include a sequence of different plants. The contents of the animated image databank 141, 61 and the background image databank 142, 62 may vary with different application fields and requirements set for the integration module 1. And, the image progress databank 143, 63 may be used to store records of changes in the progress of feeding electronic pets, for example, including the growth of the fed electronic pets.

In brief, the present invention provides an image display and touch input integration module 1 that is incorporated into a computer apparatus 2, and includes a touch module 112 functioning as an input device for the computer apparatus 2. And, a plurality of different animated image sequences and background images may be provided by the present invention for displaying on the display area 113a of the display module 113, creating more fun and completely new recreational visual effect in using the computer apparatus 2.

What is claimed is:

1. An image display and touch input integration module, comprising:
a keyboard microcontroller selectively operable in a touch mode or a display mode;
an image memory connected to the keyboard microcontroller for storing at least one image data;
a touch module connected via a touch module interface to the keyboard microcontroller, and defining a touch area therein; and
a display module integrated with the touch module, and connected via a display module interface to the keyboard microcontroller, and defining a display area therein for displaying image data read by the keyboard microcontroller from the image memory;
whereby when the keyboard microcontroller operates in the touch mode, the touch module is adapted to detect a touch signal from the touch area and send the detected touch signal to a computer apparatus, and thereby functions as an input device of the computer apparatus; and
when the keyboard microcontroller operates in the display mode, image data may be read by the keyboard microcontroller from the image memory and displayed in the display area of the display module via the display module interface.

2. The image display and touch input integration module as claimed in claim 1, wherein the image memory includes at least an animated image databank, in which a plurality of animated image sequences are stored.

3. The image display and touch input integration module as claimed in claim 1, wherein the image memory includes at least a background image databank, in which a plurality of background images are stored.

4. The image display and touch input integration module as claimed in claim 1, wherein the touch area defined by the touch module and the display area defined by the display module overlaps each other.

5. The image display and touch input integration module as claimed in claim 1, wherein the touch area defined by the touch module and the display area defined by the display module are two independent areas without overlapping each other.

6. An image display and touch input integration module, which is connected to a computer apparatus via a connection interface, and the computer apparatus including a central processing unit (CPU), a bus, and a data storage device, and the CPU being operable in a touch mode or a display mode; the integration module comprising:
at least one image databank stored on the data storage device for storing at least one image data;
a touch module connected via a touch module interface to the bus, and defining a touch area therein; and
a display module integrated with the touch module and connected via a display module interface to the bus, and defining a display area therein for displaying image data read by the CPU from the data storage device via a data storage device interface;
whereby when the CPU operates in the touch mode, the touch module is adapted to detect a touch signal from the touch area and send the detected touch signal to the CPU, and thereby functions as an input device of the computer apparatus; and
when the CPU operates in the display mode, image data may be read by the CPU from the data storage device via the data storage device interface and displayed in the display area of the display module via the display module interface.

7. The image display and touch input integration module as claimed in claim 6, wherein the image databank includes at least an animated image databank, in which a plurality of animated image sequences are stored.

8. The image display and touch input integration module as claimed in claim 6, wherein the image databank includes at least a background image databank, in which a plurality of background images are stored.

9. The image display and touch input integration module as claimed in claim 6, wherein the touch area defined by the touch module and the display area defined by the display module overlaps each other.

10. The image display and touch input integration module as claimed in claim 6, wherein the touch area defined by the touch module and the display area defined by the display module are two independent areas without overlapping each other.
